(19) United States
(12) Patent Application Publication
(10) Pub. No.: US 2025/0075709 A1
(43) Pub. Date: Mar. 6, 2025

(54) PRESSURE RELIEF ASSEMBLY FOR A HYDRAULIC PUMP

(71) Applicant: Milwaukee Electric Tool Corporation, Brookfield, WI (US)

(72) Inventor: Jonathan Kriefall, Brookfield, WI (US)

(21) Appl. No.: 18/816,231

(22) Filed: Aug. 27, 2024

Related U.S. Application Data
(60) Provisional application No. 63/579,270, filed on Aug. 28, 2023.

(51) Int. Cl. F15B 1/26; F15B 15/20

(52) U.S. Cl. CPC F15B 1/26; F15B 15/202; F15B 2211/523

(57) ABSTRACT

A hydraulic pump includes a housing including a work port, a bladder that stores hydraulic fluid, and a pump assembly that pumps hydraulic fluid from the bladder to the work port. The bladder includes a bladder relief assembly with a control element that is moveable between a first position that seals the bladder to the atmosphere and a second position that opens the bladder to the atmosphere to relieve a pressure within the bladder. The control element moves from the first position to the second position when the pressure in the bladder reaches a set pressure.

### CROSS-REFERENCE TO RELATED APPLICATIONS

This application claims the benefit of U.S. Provisional Application No. 63/579,270 filed on Aug. 28, 2023, the entire contents of which is incorporated herein by reference.

### BACKGROUND

This disclosure is directed toward hydraulic pumps and systems, and more particularly to systems and methods for a single acting, cordless hydraulic pump for use with a hydraulic tool. Hydraulic tools can be used to provide an operator with a mechanical advantage for performing work on a workpiece. For example, a hydraulic tool may be a cutting device having blades for cutting an object into separate parts. As another example, a hydraulic tool may be a crimping device for making crimping connections, thereby conjoining two separate pieces by deforming one or both pieces in a way that causes them to hold together. As yet another example, a hydraulic tool may be a lifting cylinder for lifting a workpiece and/or a pipe bender for bending a workpiece.

In general, a hydraulic tool is coupled to a hydraulic pump, which is operable to pressurize a hydraulic fluid. The hydraulic pump transfers the pressurized hydraulic fluid to a cylinder in the hydraulic tool, and the hydraulic tool uses the pressurized hydraulic fluid from the hydraulic pump to perform the work, e.g., crimping, cutting, lifting, etc. The hydraulic pump, therefore, requires mechanisms to pressurize the hydraulic fluid, maintain the pressure, and release the pressure.

### SUMMARY

According to one aspect of the present disclosure, a hydraulic pump may include a housing including a work port, a bladder that stores hydraulic fluid, and a pump assembly that pumps hydraulic fluid from the bladder to the work port via an outlet line. The bladder can include a bladder relief assembly that is coupled to the bladder. The bladder relief assembly may include a control element that is moveable between a first position that seals the bladder to the atmosphere and a second position that opens the bladder to the atmosphere to relieve a pressure within the bladder. The control element can move from the first position to the second position when the pressure in the bladder reaches a set pressure.

In some examples, the hydraulic pump may further include a release valve positioned between the work port and the bladder to control fluid flow between the work port and the bladder.

In some examples, the release valve can include a knob extending outside the housing to allow a user to manipulate the release valve.

In some examples, the set pressure of the bladder relief assembly may be adjustable.

In some examples, the bladder can further include a removable fill cap.

In some examples, the bladder relief assembly may be coupled to the fill cap.

In some examples, the fill cap can extend outside of the housing.

In some examples, the fill cap may include a head and a stem that couples to the bladder. The control element can be moveably disposed in a passage extending between the head and the stem.

In some examples, the head may include a first passage. The stem can include a second passage that is selectively fluidly coupled by the control element.

In some examples, the first passage may extend toward the stem and radially outward from the head.

In some examples, the head can define a flange and a distal end of the first passage is positioned along a side of the flange that faces the bladder.

In some examples, the housing may include a battery receptacle configured to couple a battery to provide electrical power to the hydraulic pump.

In some examples, the hydraulic pump can further include a work port coupled to a manifold disposed inside the housing to allow fluid flow between the bladder and the work port. The work port may be configured to couple to an end effector that performs a work operation.

According to another aspect of the present disclosure, a bladder assembly for a hydraulic tool can include a reservoir defining an internal cavity configured to receive hydraulic fluid and a fill cap removably coupled to the reservoir. The fill cap may define a passageway and can include a control element moveably disposed along the passageway. The control element may be movable between a first position that seals the internal cavity to the atmosphere and a second position that vents the internal cavity to the atmosphere to relieve a pressure within the bladder. The control element can move from the first position to the second position when the pressure in the bladder reaches a set pressure.

In some examples, the set pressure may be an adjustable set pressure.

In some examples, the fill cap can include a stem that couples to the reservoir and a head that extends from the stem to be manipulable by a user. The head may include a first segment of the passageway that extends toward an outer perimeter of the head and toward the reservoir.

According to another aspect of the present disclosure, a power tool can include a housing including a battery respectable, a drive unit disposed within the housing, a pump operatively coupled to the drive unit to provide a pressurized fluid, a trigger that allows a user to control the drive unit to operate the power tool, and a bladder assembly disposed in the housing. The bladder assembly may include a reservoir defining an internal cavity configured to receive hydraulic fluid and a fill cap removably coupled to the reservoir. The fill cap can define a passageway and may include a control element moveably disposed along the passageway. The control element can be movably between a first position that seals the internal cavity to the atmosphere and a second position that vents the internal cavity to the atmosphere to relieve a pressure within the blader when the pressure in the bladder reaches a set pressure.

In some examples, the fill cap may extend outside the housing to allow a user to vary the set pressure.

The power tool can include a manifold having a work port that couples to an end effector that performs a work operation.

In some examples, the bladder may include a mounting bracket coupled between the reservoir and the fill cap. The mounting bracket can be couplable to the housing.

The features, functions, and advantages can be achieved independently in various embodiments of the present disclosure or may be combined in yet other embodiments in which further details can be seen with reference to the following description and drawings.

### BRIEF DESCRIPTION OF THE DRAWINGS

The accompanying drawings, which are incorporated in and form a part of this specification, illustrate embodiments of the invention and, together with the description, serve to explain the principles of embodiments of the invention:

FIG. 1 is a front axonometric view of a hydraulic pump according to an embodiment of the disclosure;

FIG. 2 is a rear axonometric view of the hydraulic pump of FIG. 1;

FIG. 3 is a schematic illustration of a hydraulic power tool system that includes the hydraulic pump of FIG. 1;

FIG. 4 is partial a cross-sectional view of a pump, manifold, and bladder assembly of the hydraulic pump of FIG. 1;

FIG. 5 is a detail view of an indicator of the hydraulic pump of FIG>1, taken about line IV-IV;

FIG. 6 is an axonometric view of a bladder relief assembly of the hydraulic pump of FIG. 1;

FIG. 7 is another axonometric view of the bladder relief assembly of FIG. 6;

FIG. 8 is a cross-sectional view of the bladder relief assembly of FIG. 6, taken through line VIII-VIII;

FIG. 9 is a cross-sectional and axonometric view of the bladder relief assembly of FIG. 8;

FIG. 10 is an axonometric view of a fill cap of the bladder relief assembly of FIG. 6;

FIG. 11 is a cross-sectional view of the fill cap of FIG. 9, taken through line XI-XI;

FIG. 12 is a schematic illustration of a hydraulic power tool system including a hydraulic pump of FIG. 1;

FIG. 13 is a flow chart of an open-loop motor speed control method of the hydraulic power tool system of FIG. 12; and

FIG. 14 is a flow chart of a closed-loop motor speed control method of the hydraulic power tool system of FIG. 12.

### DETAILED DESCRIPTION

The concepts disclosed in this discussion are described and illustrated with reference to exemplary arrangements. These concepts, however, are not limited in their application to the details of construction and the arrangement of components in the illustrative embodiments and are capable of being practiced or being carried out in various other ways. The terminology in this document is used for the purpose of description and should not be regarded as limiting. Words such as “including,” “comprising,” and “having” and variations thereof as used herein are meant to encompass the items listed thereafter, equivalents thereof, as well as additional items.

Unless otherwise specified or limited, the terms “about” and “approximately,” as used herein with respect to a reference value, refer to variations from the reference value of ±20% or less (e.g., ±15, ±10%, ±5%, etc.), inclusive of the endpoints of the range. Similarly, as used herein with respect to a reference value, the term “substantially equal” (and the like) refers to variations from the reference value of ±5% or less (e.g., ±2%, ±1%, ±0.5%) inclusive. Where specified in particular, “substantially” can indicate a variation in one numerical direction relative to a reference value. In particular, the term “substantially less” than a reference value (and the like) indicates a value that is reduced from the reference value by 30% or more (e.g., 35%, 40%, 50%, 65%, 80%), and the term “substantially more” than a reference value (and the like) indicates a value that is increased from the reference value by 30% or more (e.g., 35%, 40%, 50%, 65%, 80%).

In general, hydraulic pumps can be used to convert mechanical power into hydraulic energy. As briefly described above, hydraulic pumps can be used in a variety of environments, such as to power tools or charge hydraulic systems. Pumps can be integrated into a power tool or can be configured as a stand-along pump that can couple to different types of end effectors to perform a variety of work operations. Thus, hydraulic pumps disclosed herein may be embodied in many different forms. Several specific embodiments are discussed herein with the understanding that the embodiments described in the present disclosure are to be considered only exemplifications of the principles described herein, and the disclosed technology is not intended to be limited to the examples illustrated.

Generally, some embodiments provide a single acting, battery operated, hydraulic pump for use with a hydraulic tool. “Single acting” may generally refer to a type of pump that moves fluid only during one stroke of a piston or a plunger; however other pump types (e.g., double acting) are possible. In some embodiments, the hydraulic pump can include a variable speed motor and a pump controller configured to control the variable speed motor using open loop control based on a percentage of motor power applied or using closed loop control based on actual motor speed. Furthermore, the hydraulic pump can include a manifold with an overpressure protection system including dual chambers with respective relief valves and a check valve therebetween. The overpressure protection system can release pressurized fluid into the atmosphere to prevent pump overpressure events as well as external load overpressure events.

For example, an overpressure protection system can include a bladder relief assembly. The bladder relief assembly can be used to protect the hydraulic pump or system from over pressurization. The bladder relief assembly can be advantageously incorporated into a fill cap for a hydraulic pump. By incorporating the bladder relief assembly into the fill cap, the number of ports between the hydraulic tank or reservoir and the atmosphere can be reduced compared to conventional approaches of relief valves and ports. In general, the bladder relief assembly can be opened when pressure in a bladder of the hydraulic pump exceeds a set pressure. The bladder relief assembly can allow air and fluid to vent to the atmosphere (e.g., outside of the pump) when there is excess fluid in the bladder.

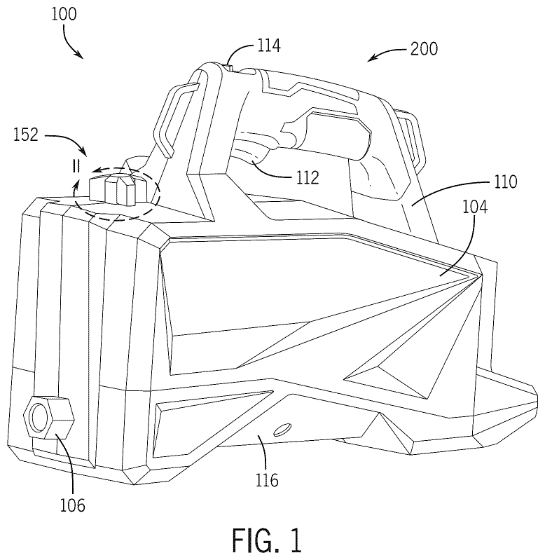

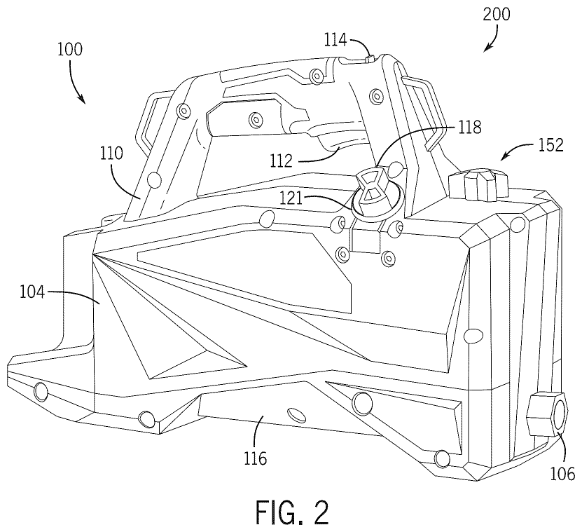

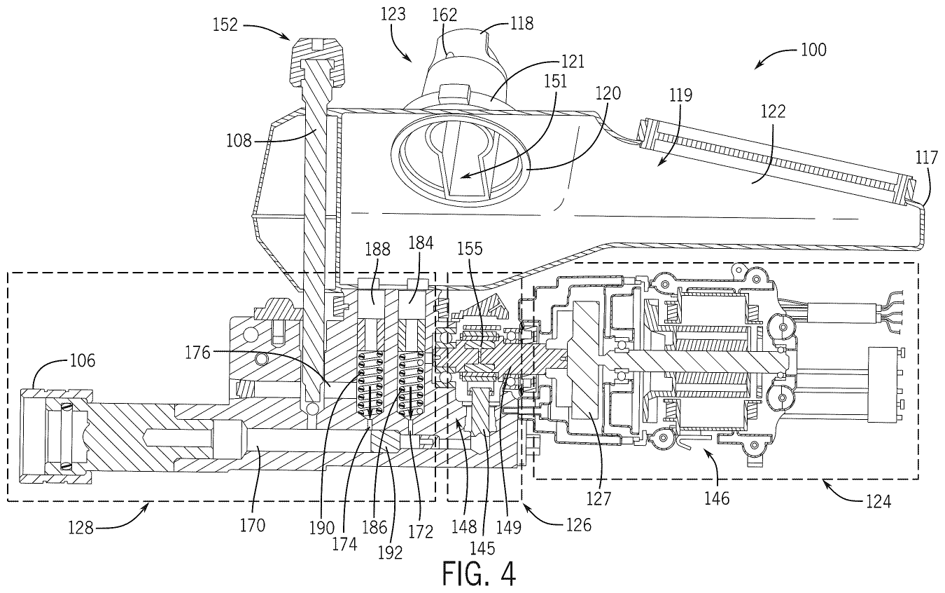

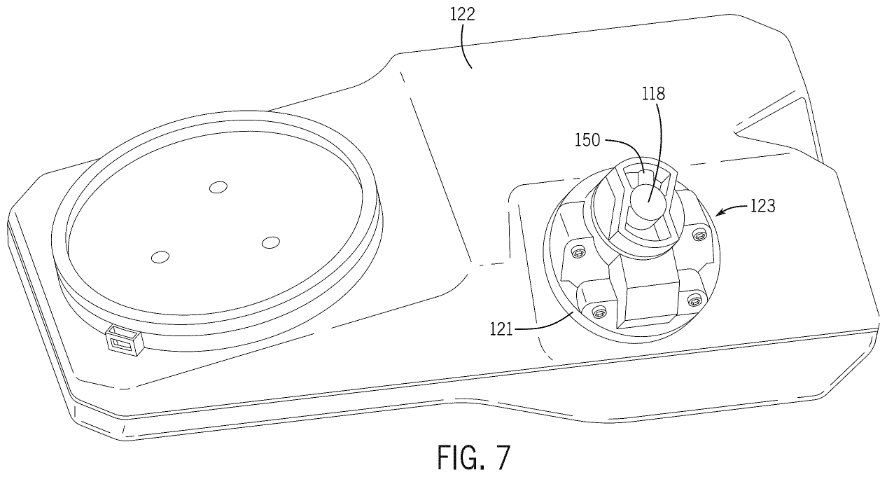

Referring now to FIGS. 1 and 2, a hydraulic pump 100 is shown. The hydraulic pump 100 can be configured as a single acting hydraulic pump; however, other configurations are possible. The hydraulic pump 100 can be part of a hydraulic power tool system 200, according to some embodiments of the disclosure. As shown in FIGS. 1 and 2, the hydraulic pump 100 can include a housing 104, a work port 106, a cap 152, a first indicator 153, a second indicator 154, a handle 110, a trigger 112, a lock 114, and battery receptacle 115 that includes a battery terminal 116 configured to couple to one or more batteries. As shown in FIG. 2, the hydraulic pump 100 (e.g., a bladder thereof) can further include a fill cap 118. Put another way, the bladder 122 includes a fill cap 118 and a reservoir 117 (see FIG. 4) defining an interior cavity 119 (see FIG. 4) that retains fluid for the hydraulic pump 100. In some cases, the reservoir can be a flexible bag or the reservoir can be a rigid container. The bladder may include a mounting bracket 121 coupled to the housing 104 and further between the reservoir 117 and the fill cap 118. In the illustrated embodiment, the fill cap 118 can be coupled to an opening 120 of a bladder 122 (see FIG. 7). For example, the fill cap 118 may be threadably coupled to the opening 120 of the bladder 122, however; other means of securing are possible, e.g., snap-fit, press-fit. Furthermore, in the illustrated embodiment, the fill cap 118 can include a bladder relief assembly 123, as will be described in further detail below.

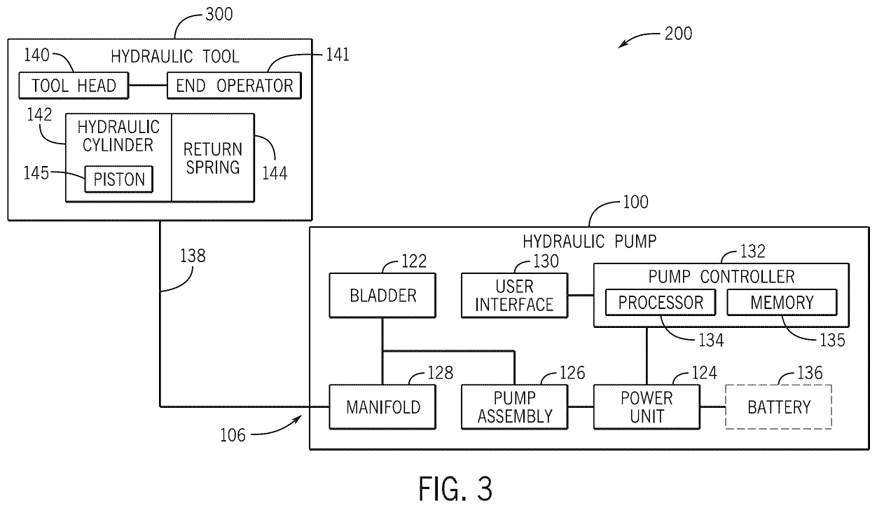

FIG. 3 illustrates the hydraulic power tool system 200 including the hydraulic pump 100 and a hydraulic tool 300 (e.g., an end effector configured to perform a type of work operation, for example, crimping, cutting, drilling, punching, lifting, expanding, etc.). Generally, the hydraulic pump 100 can be operated to provide a pressurized fluid (e.g., a hydraulic oil) to actuate the hydraulic tool 300. For example, as shown in FIG. 3, the hydraulic pump 100 can include a power unit 124, a pump assembly 126, a manifold 128, the bladder 122, a user interface 130, a controller 132 with a processor 134 and memory 135, the work port 106, and a power source or battery 136. The hydraulic pump 100 can be removably coupled to the hydraulic tool 300 via a fluid supply line 138, such as tubing, extending from the work port 106. Furthermore, the hydraulic tool 300 can include a tool head 140, a hydraulic cylinder 142, and a return spring 144.

In operation, the power unit 124 can be powered by the battery 136 to drive the pump assembly 126. The power unit 124 can be controlled by the controller 132 in response to user input from the user interface 130 (e.g., response to a trigger 112 depression). The pump assembly 126 pumps pressurized fluid from the bladder 122 through the manifold 128, which connects between the pump assembly 126 and the bladder 122, and through the fluid supply line 138 to the hydraulic tool 300 via the work port 106. Within the hydraulic tool 300, the pressurized fluid pushes the hydraulic cylinder 142, which actuates the tool head 140. For example, the hydraulic tool 300 (e.g., the tool head 140) may include an end operator 141 to perform a work function, for example, a set of jaws, and the hydraulic cylinder 142 includes a piston 145 that can move one or both jaws toward each other, causing a crimping or cutting operation. In another example, the end operator 141 can be a movable lift structure, and the hydraulic cylinder 142 can move the movable lift structure to change an elevation of a workpiece supported by the movable lift structure. Other examples are possible such as, but not limited to, tool heads 140 with moveable elements (e.g., a bend die and/or a bend roll) that can move a workpiece relative to a stationary element (e.g., a stationary die and/or a stationary roll) to change a shape of the workpiece.

Once an operation is completed, the return spring 144 can force the fluid from the hydraulic tool 300, through the fluid supply line 138, and back into the hydraulic pump 100 and more specifically, into the bladder 122. In this manner, the hydraulic pump 100 is a single action pump. The hydraulic pump 100 includes a work port 106 and forces fluid in one direction, and the hydraulic tool 300 includes a spring, or gravity or another external force, to return the fluid back to the hydraulic pump 100. As a result, the external force, rather than the hydraulic tool 300 or a user, releases pressure within the hydraulic tool 300 to force the fluid back into the hydraulic pump 100.

The internal view of FIG. 4 illustrates the power unit 124, the pump assembly 126, the manifold 128, the bladder 122, and the cap 152. As shown in FIG. 4, the power unit 124 can include a motor 146 configured to convert electrical energy to rotational motion in order to operate the pump assembly 126. Further, in some embodiments, the power unit 124 can comprise the motor 146 with a transmission 127. In the embodiment shown, the transmission 127 includes a planetary gearset, however; the transmission 127 may be a manual transmission, an automatic transmission, a hydraulic transmission, or a gearbox torque converter, or other transmission types are possible. In some embodiments, the motor 146 can be a variable speed motor. In some embodiments, the motor 146 can be a brushless direct current (DC) motor.

The power unit 124 can be powered by a power source, such as the battery 136, as shown in FIG. 3. The hydraulic pump 100 can, therefore, be considered a cordless pump as it is battery-operated. In some embodiments, the battery 136 can be an 18-volt battery, a 12-volt battery, a 20-volt battery, or another battery voltage. The battery 136 can be lithium-ion battery, a nickel-cadmium battery, or another type of battery chemistry. Furthermore, in some embodiments, the battery 136 can be removable from the hydraulic pump 100. For example, as shown in FIGS. 1 and 2, the hydraulic pump 100 can include the battery terminal 116, onto which the battery 136 can be removably coupled. As a result, the battery 136 can be removed from the hydraulic pump 100 and recharged and/or replaced, when necessary.

Furthermore, the power unit 124 can be controlled by the controller 132. As such, the controller 132 can be in communication with the motor 146. The controller 132 can be implemented using hardware, software, and/or firmware. For example, as shown in FIG. 3, the controller 132 can include one or more processors 134 and memory 135 (e.g., a non-transitory computer readable memory) that stores machine language instructions or other executable instructions. The instructions, when executed by the one or more processors 134, can cause the controller 132 to carry out various operations of the hydraulic pump 100.

For example, the memory 135 can include instructions that, when executed by the processor(s) 134, cause the controller 132 to operate the motor 146 in response to user input from an operator. Such user input can be the operator depressing the trigger 112. As shown in FIGS. 1 and 2, the trigger 112 can be located along the handle 110 of the housing 104, allowing an operator to grasp the handle 110 and actuate the trigger 112. However, in other embodiments, the trigger 112 may be located elsewhere along the housing 104.

In some embodiments, the trigger 112 may act as an on-off switch, such that the controller 132 turns on and runs the motor 146 to operate the pump assembly 126 when the trigger 112 is depressed and turns off the motor 146 when the trigger 112 is released. In other embodiments, as further described below, the trigger 112 may be a variable trigger such that the controller 132 controls the motor 146 speed in direct relation to an amount of force applied to the trigger 112, or an amount of trigger 112 travel (i.e., from undepressed state to fully depressed state). In other examples, the trigger 112 can be another type of trigger, such as an on/off switch, a stepped trigger, etc. In such embodiments, the controller 132 still turns off the motor 146 when the trigger 112 is no longer depressed. Additionally, in some embodiments, the hydraulic pump 100 can include additional user input to prevent motor operations. For example, as shown in FIGS. 1 and 2, the hydraulic pump 100 can include the lock 114, such as on the handle 110, that prevents accidental trigger pulls. In some embodiments, the lock 114 can be a mechanical lock that prevents the trigger 112 from being depressed. In other embodiments, the lock 114 can be an electronic lock that, when actuated, sends a signal to the controller 132 to prevent motor operation.

With further reference to the pump assembly 126, as shown in FIGS. 3 and 4, the pump assembly 126 can include a pump 148 coupled to the power unit 124. In some embodiments, the pump 148 can be a radial pump, including a piston 145 and a cam 155 driven by the motor 146. For example, as shown in FIG. 4, the pump 148 can include a shaft 149 operably coupled to the motor 146. The cam 155 is coupled to the shaft 149 and rotates with the shaft 149. The cam 155 acts on a piston 145 to convert the rotational motion of the motor 146 into reciprocating linear motion of the piston 145. The reciprocating, linear motion of the piston 145 withdraws fluid out of the bladder 122 and supplies pressurized fluid through the manifold 128 to the work port 106 and through the fluid supply line 138 to the hydraulic tool 300. It is appreciated that valves or other fluid control mechanisms may be provided to prevent backflow from the piston 145.

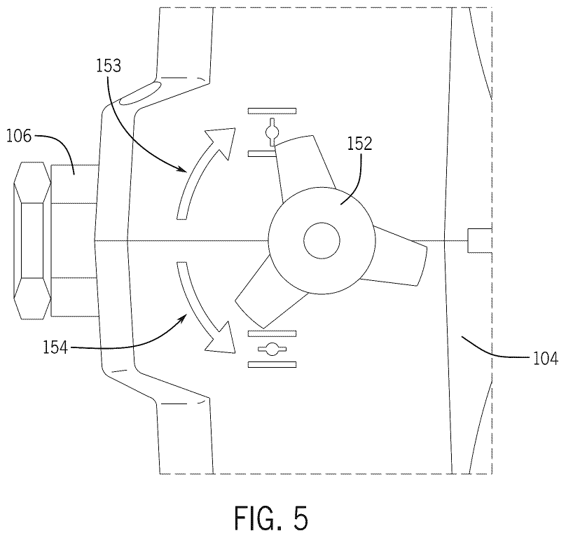

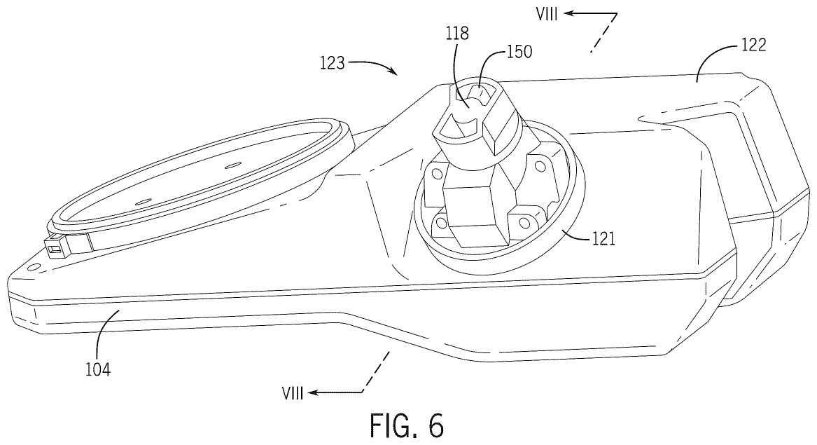

FIGS. 5 and 6 illustrate an axonometric view of the bladder 122 assembly, including a bladder relief assembly 123 of the hydraulic pump 100. As shown in FIG. 4, the bladder 122 operates as a reservoir (e.g., a tank) for storing hydraulic fluid (e.g., hydraulic oil). In some embodiments, the bladder 122 can include the opening 120 covered by the fill cap 118. The opening 120 can act as a fill port, and the fill cap 118 can be removed to allow for removal and/or refilling of hydraulic fluid from the bladder 122 via the opening 120. Furthermore, in some embodiments, the fill cap 118 or another portion of the housing 104 can include a transparent window 151 to allow an operator to view inside the bladder 122. As a result, the operator can quickly check a level of hydraulic fluid within the bladder 122 without having to take off the fill cap 118.

As noted above, the bladder 122 can further include the bladder relief assembly 123. In the illustrated embodiment, the bladder relief assembly 123 can be integrated into the fill cap 118. In general, the bladder relief assembly 123 can be configured as part of an overpressure protection system 147. The bladder relief assembly 123 can include a relief valve 150 disposed within the fill cap 118. The relief valve 150 can define a set pressure at which a relief event happens via the relief valve 150. In some embodiments, the relief valve 150 can also define other pressure thresholds, such as a crack pressure at which the relief valve 150 first opens, the crack pressure being less than the set pressure. For example, the crack pressure can ensure the relief valve 150 activates and opens before pressure in the bladder 122 reaches the set pressure. In general, the bladder relief assembly 123 can protect the hydraulic pump 100, a tool (e.g., the hydraulic tool 300), and the bladder 122. That is, when pressure in the bladder 122 exceeds a set pressure (e.g., between about 8,000 PSI and about 12,000 PSI, or between about 10,000 PSI and about 10,500 or about 10,152 PSI), the relief valve 150 opens, allowing fluid to vent into the atmosphere. In some examples, a user may select the crack pressure or the set pressure at which the relief valve 150 may open, depending on the amount of pressure the user needs the hydraulic pump 100 to output for various operations that can provide overpressure protection to the hydraulic pump 100 and the hydraulic tool 300 at different pressures. This same release can also occur when excess fluid enters the bladder 122.

The bladder 122 can store the hydraulic fluid a low-pressure level, such as atmospheric pressure or slightly higher than atmospheric pressure (e.g., about 30 psi to about 70 psi in some embodiments). As noted above, the pump assembly 126 withdraws fluid from the bladder 122 and forces pressurized fluid through the fluid supply line 138 into the hydraulic tool 300 to perform a work operation. Additionally, as shown in FIGS. 3 and 4, the fluid travels through the manifold 128 between the pump assembly 126, the bladder 122, and the work port 106.

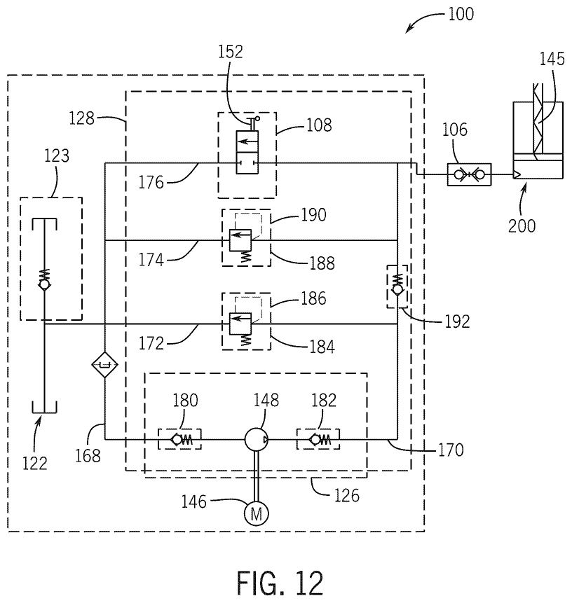

Generally, the manifold 128 can provide fluid control, set operating pressures, and/or provide overpressure relief. For example, a release valve 108 (e.g. a manual release valve), accessible to an operator from outside the housing 104, can be manipulated by a user to build fluid pressure or throttle return flow. More specifically, as shown in FIG. 4 the release valve 108 can include the cap 152 (e.g., configured as a knob) extending from the housing 104 that can be moved by an operator. Internally, as shown in FIG. 12, the release valve 108 can communicate with a third manifold line 176 between the bladder 122 and the work port 106. The first indicator 153 (FIG. 5) and the second indicator 154 (FIG. 5) may visually indicate to a user the whether the release valve 108 is in a blocking position to block fluid communication between the third manifold line 176 and the bladder 122, as indicated by the first indicator 153, or if the release valve 108 is in an open position to allow fluid communication between the third manifold line 176 and the bladder 122, as indicated by the second indicator 154. For example, when an operator turns the cap 152 in a first rotational direction (e.g., clockwise) to a first (e.g., “closed”) position (e.g., as is visible to the operator by the first indicator 153), the release valve 108 is moved to block the third manifold line 176, thereby preventing fluid from traveling from the work port 106 back to the bladder 122. This closure, in turn, allows the pump 148 to deliver pressurized fluid through the work port 106 and maintain the pressure. When an operator turns the cap 152 in a second rotational direction (e.g., anti-clockwise) to a second “open” position (e.g., as is visible to the operator by the second indicator 154), the release valve 108 is moved to open the third manifold line 176, thereby opening the connection between the work port 106 and the bladder 122, allowing fluid to travel from the work port 106 back to the bladder 122. As a result, pressure is released from the bladder 122 and fluid returns from the hydraulic tool 300 back to the bladder 122 via the third manifold line 176 (e.g., due to the spring or other external force within the hydraulic tool 300 forcing the fluid out of the hydraulic tool 300).

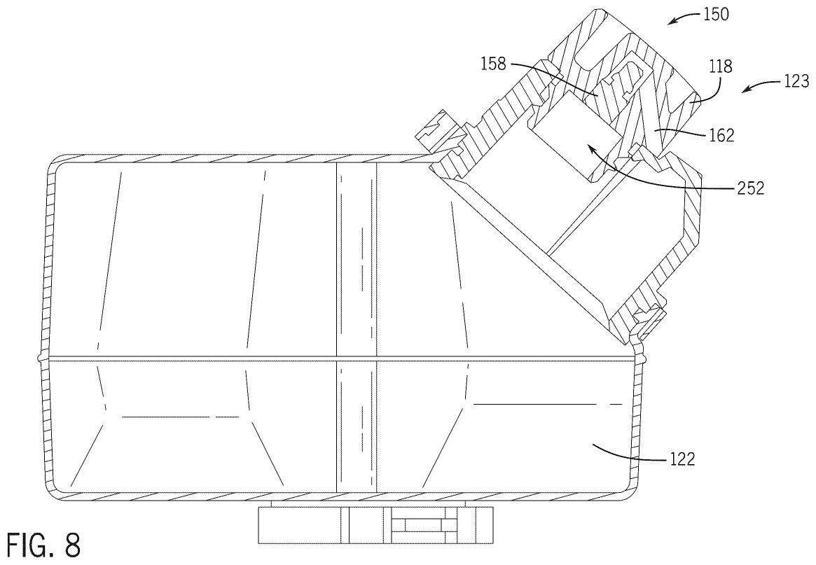

FIG. 8 illustrates a cross-sectional view of the bladder 122 and bladder relief assembly 123 with the fill cap 118. As shown, the relief valve 150 can be directly integrated into the fill cap 118. The relief valve 150 can include a control element 158 configured as a valve poppet In general, the control element 158 can sense fluid pressure within the bladder 122. When the pressure within the bladder 122 exceeds the set pressure of the relief valve 150, the control element 158 can move (e.g., unseat) and vent fluid through an opening 162 (see FIG. 8) (e.g., a first passage) in the fill cap 118.

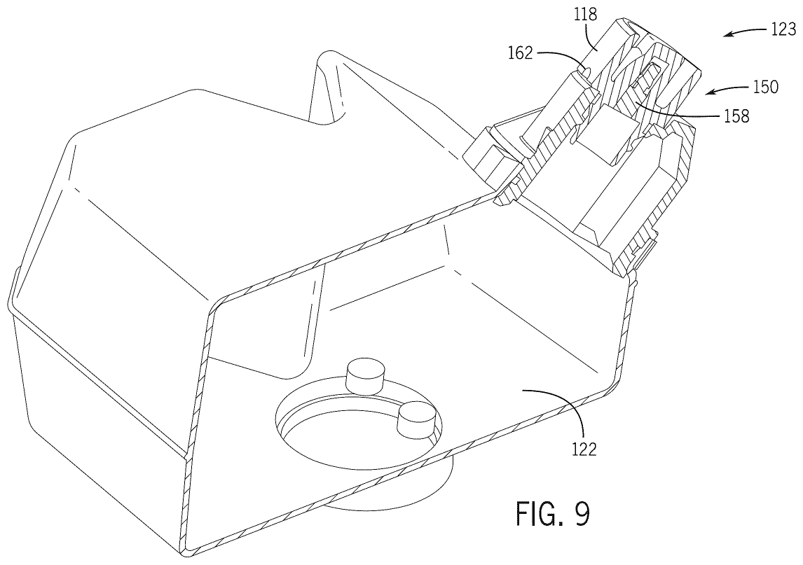

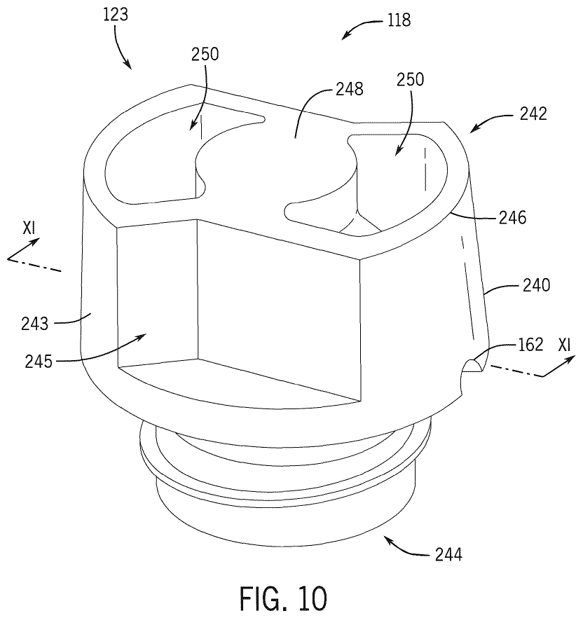

FIGS. 9 and 10 illustrate the fill cap 118, according to an embodiment of the disclosure. The fill cap 118 can include a fill cap body 240 having a head 242 and a stem 244. The head 242 can define a flange 243 and a grip portion 245. The stem 244 can includes threads that are configured to be threadably received by the inside of the opening 120 of the bladder 122. As noted above, the fill cap 118, and more specifically, the stem 244 may be secured over the opening 120 of the bladder 122 by other means, such as snap-fit or press-fit, although other configurations are possible. The head 242 of the fill cap 118 can include a collar 246 and a hub 248. The collar 246 and the hub 248 can be generally concentric and radially separated so that one or more recesses 250 are formed therebetween. The recesses 250 and other geometric features of the fill cap 118 can advantageously aid a user in gripping and securing (e.g., coupling) the fill cap 118 to the bladder 122 or removing (e.g., decoupling) the fill cap 118 from the bladder 122.

As shown in FIG. 10, the stem 244 can define a passageway 252 (e.g., a second passage) extending therethrough. The passageway 252 can be in fluid communication with the control element 158 and the bladder 122 when the fill cap 118 is secured to the bladder 122. The passageway 252 can also be in fluid communication with the opening 162 in the fill cap 118 when the control element 158 is in a venting position, such that the passageway 252 and the opening 162 define a passageway though the fill cap 118 between the inside of the bladder 122 and the atmosphere. As shown in FIG. 10, the opening 162 can extend from inside the fill cap 118 through each of the collar 246 and hub 248 walls of the head 242. Put another way, the opening 162 extends through the head 242 so that a distal end of the opening 162 is positioned along a side (e.g., an underside) of the flange 243 that faces the bladder 122 or the housing 104 (e.g., away from a user). Thus, during a relief event, fluid can be relieved from inside the bladder 122 to the atmosphere through the passageway 252 and the opening 162 via the control element 158.

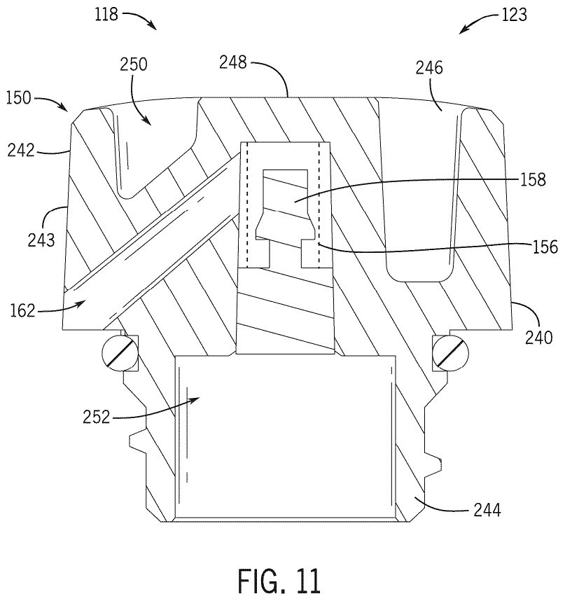

In use, the control element 158 is in a normally closed position (e.g., in a seated position) so that fluid communication between the passageway 252 and the opening 162 is blocked. As shown in FIG. 11, the control element 158 can be biased to a closed position by a biasing element 156. As pressure increases in the bladder 122, the control element 158 remains in a closed position until the set pressure of the relief valve 150 is reached. During a relief event, the control element 158 moves toward the hub 248 (e.g., away from the stem 244) to an open position (e.g., in an unseated position). When the relief valve 150 opens, excess fluid vents to the atmosphere through the opening 162 in the fill cap 118, reducing the pressure in the bladder 122 to an amount lower than the set pressure. This in turn can protect the bladder 122 and the hydraulic tool 300 from over pressurization. As shown in FIGS. 8-10, the fill cap 118 position is independent on the pressure overprotection capability of the relief valve 150. That is, the opening 162 can be in a variety of rotational positions with respect to the opening 120 of the bladder 122 without affecting the relief capabilities of the bladder relief assembly 123. In the illustrated embodiment, the hub defines a in an oblique direction from the hub 248 toward an end of the fill cap body 240 near the stem 244 (e.g., toward the stem 244 and radially outward). This advantageously ensures that when excess fluid exits through the opening 162 in a relief event, the fluid may be directed away from the hub 248 and in a direction away from a user. In some embodiments, it may be advantageous to point the opening 162 in a strategic direction, such as away from tools, manifolds, or users.

As discussed above and also shown in FIG. 4, with reference now to FIG. 12, a schematic illustration of the hydraulic pump 100 is shown. As described above, the hydraulic pump 100 can include the manifold 128. In some embodiments, the manifold 128 can include a relief and check valve arrangement that provides the hydraulic pump 100 with overpressure protection, in addition to the relief valve 150 in the fill cap 118. FIG. 12 illustrates fluid connections between the bladder 122, the pump assembly 126, the manifold 128, and the hydraulic tool 300. For example, the hydraulic pump 100 includes a pump inlet line 168 between the bladder 122 and the pump assembly 126, an outlet line 170 between the pump assembly 126 and the work port 106 and extending through the manifold 128, a first manifold line 172 between the bladder 122 and the outlet line 170, a second manifold line 174 between the bladder 122 and the outlet line 170, and the third manifold line 176 between the bladder 122 and the outlet line 170.

Referring still to FIG. 12, as noted above, the bladder 122 can store hydraulic fluid at or near atmospheric pressure. In some embodiments, the bladder 122 can include the bladder relief assembly 123 release to maintain pressure within the bladder 122 at or below a pressure threshold. Additionally, within the pump assembly 126, a first check valve 180 (FIG. 12) is located between the pump 148 and that bladder 122, along the pump inlet line 168, and a second check valve 182 (FIG. 12) is located between the pump 148 and a third check valve 192, along the outlet line 170. The first and second check valves 180, 182 can permit fluid movement from the bladder 122 through the pump 148 and prevent fluid backflow from the pump 148 to the bladder 122, thus enabling proper operation of the pump 148 to provide pressurized fluid through the outlet line 170.

Referring still to FIG. 12, the manifold 128 can contain at least a portion of the outlet line 170. Within the manifold 128, the hydraulic pump 100 can include the first chamber 184 (FIG. 4), a first relief valve 186, a second chamber 188 (FIG. 4), a second relief valve 190, the check valve 192, and the release valve 108. Via the outlet line 170, the first chamber 184 can be connected to the pump assembly 126, the second chamber 188 can be connected to the first chamber 184, and the work port 106 can be connected to the second chamber 188 (which may further be connected to the hydraulic tool 300). The check valve 192 can be positioned along the outlet line 170 between the first chamber 184 and the second chamber 188 to permit fluid flow from the first chamber 184 to the second chamber 188 and prevent fluid flow from the second chamber 188 to the first chamber 184.

The first relief valve 186 can be connected to the first chamber 184 so that, when the first chamber 184 reaches a first pressure, the first relief valve 186 opens to permit fluid flow from the outlet line 170 back to the bladder 122 via the first manifold line 172. As a result, pressure within the outlet line 170 drops when the first pressure is reached, which can protect the pump assembly 126 from creating too much pressure within the hydraulic pump 100. Thus, the first chamber 184 and first relief valve 186 can serve as a primary pump overpressure protection mechanism.

Furthermore, the second relief valve 190 can be connected to the second chamber 188 such that, when the second chamber 188 reaches a second pressure, the second relief valve 190 opens to permit fluid flow from the outlet line 170 back to the bladder 122 via the second manifold line 174. As a result, pressure within the outlet line 170 drops when the second pressure is reached, which can protect the hydraulic pump 100 from overpressures from external loads (e.g., from the hydraulic tool 300). Furthermore, the second chamber 188 and the second relief valve 190 can serve as a secondary pump overpressure protection mechanism. For example, in some embodiments, the first relief valve 186 can be set at a lower pressure than the second relief valve 190. Therefore, if the first relief valve 186 fails, the second relief valve 190 can still relieve the pump overpressure. In one embodiment, the first pressure is about 10,250 psi and the second pressure is about 11,500 psi. In such embodiments, the hydraulic pump 100 may be considered to be rated at 10,000 psi.

As noted above, in some embodiments, the controller 132 can operate the motor 146 at variable speeds, for example, in relation to an operator's force applied to the trigger 112 or an amount of trigger 112 travel. For example, FIGS. 11 and 12 illustrate methods of variable motor speed control according to some embodiments. In some embodiments, the methods of FIGS. 11 and 12 can executed by the controller 132 (e.g., can be stored in the memory to be executed by the processor of the controller 132). It should be noted that, while certain steps are illustrated in FIGS. 11 and 12 and described below in a particular order, in some embodiments, the steps may be executed in simultaneously with other steps, or in a different order than that shown and described, or more or fewer steps may be executed.

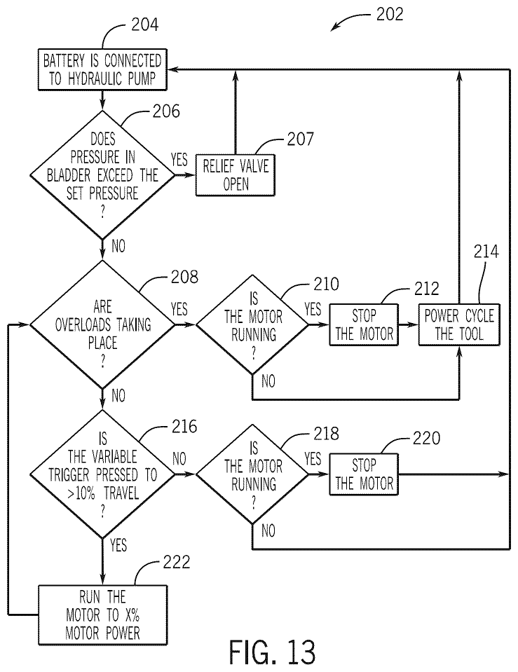

For example, FIG. 13 illustrates a method 202 for open-loop control. Generally, method 202 of FIG. 13 is executed by varying motor 146 power. More specifically, at step 204, the battery 136 is connected to the hydraulic pump 100, thus supplying power to the hydraulic pump 100. At step 206, the controller 132 determines if the pressure in the bladder 122 has exceeded the set pressure. If the bladder pressure exceeds the set pressure, the relief valve 150 opens at step 207 and returns to step 204. If the pressure in the bladder 122 does not exceed the set pressure, the controller 132 proceeds to step 208, and determines whether any overloads are taking place (e.g., an operating parameter of the system that is outside of a predetermined range o\r threshold). For example, an overload may be detected when the motor 146 is drawing current above a threshold value. As another example, an overload may be detected when a temperature of the motor 146 exceeds a threshold value.

If an overload is detected, as determined at step 208, the controller 132 determines if the motor 146 is running at step 210. If so, the controller 132 stops the motor 146 at step 212. If not, or following the controller 132 stopping the motor 146 at step 212, the controller 132 power cycles the hydraulic pump 100 at step 214. For example, the controller 132 may conduct a power cycling operation by uncoupling the electrical connection the battery 136 from the motor 146 and then restoring the electrical connection between the battery 136 and the motor 146. After power cycling at step 214, the controller 132 returns to step 204.

Returning back to step 208, if an overload is not detected, the controller 132 determines whether the trigger 112 is pressed to greater than about 10% of its total travel at step 216 (e.g., the “total travel” being a fully depressed state). If not, the controller 132 determines if the motor 146 is running at step 218. If the motor is running, the controller 132 stops the motor 146 at step 220. If the motor is not running, or following the controller 132 stopping the motor 146 at step 220, the controller 132 returns to step 204.

Returning back to step 216, if the trigger 112 is pressed to greater than about 10% of its total travel, the controller 132 operates the motor 146 at a percentage motor power that correlates to the percentage travel of the trigger 112 at step 222. For example, if the trigger 112 travel is 50%, the controller 132 can operate the motor 146 at 50% motor 146 power. As another example, if the trigger 112 travel is 100% (i.e., the trigger 112 is fully depressed), the controller 132 can operate the motor 146 at 100% power. Furthermore, the controller 132 loops back to step 208 to continuously check for overloads while operating the motor 146.

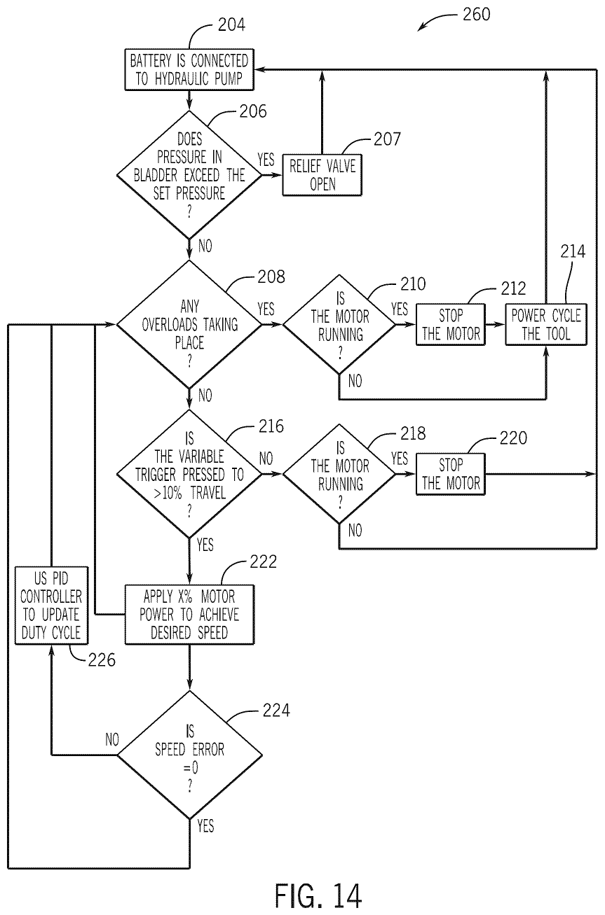

FIG. 14 illustrates a closed-loop variable speed motor control method 260. Generally, the closed-loop method of FIG. 14 controls actual motor speed, e.g., in rotations per minute (RPM). The closed-loop method of FIG. 14 may include similar steps initially as the open-loop method of FIG. 13 and, thus, like steps are numbered accordingly. However, following step 216, if the trigger 112 is pressed to greater than 10% of its total travel, the controller 132 operates the motor 146 at a percentage motor power that correlates to the percentage travel of the trigger 112 to achieve a desired speed at step 222. The controller 132 then determines whether a speed error is zero at step 226. That is, the controller 132 determines if the actual pump speed (e.g., motor speed) is equal to the desired pump speed. If so, the controller 132 loops back to step 208 to continuously check for overloads while operating the motor 146. If, at step 224, the speed error does not equal zero, the controller 132 uses a proportional-integral-derivative control mechanism to update a duty cycle of the motor 146 at step 226 in attempt to match the actual motor speed to the desired motor 146 speed. The controller 132 then loops back to step 208 to continuously check for overloads while operating the motor 146.

The motor 146 (or, more generally, the power unit 124) can be operated according to the methods described herein, or other methods not specifically described here, to actuate the pump assembly 126 in order to provide pressurized fluid to the hydraulic tool 300. For example, the motor 146 can actuate the pump assembly 126 to pump fluid to the hydraulic tool 300 at an increasing fluid pressure until reaching a maximum operating pressure. The rate at which fluid pressure increases toward the maximum operating pressure can correlate to the speed at which the motor 146 is controlled as well as external loads from the hydraulic tool 300. Accordingly, by being able to vary motor 146 speed, as described above, the pump speed (e.g., motor speed) can also be controlled.

In light of the above, some embodiments provide a battery operated hydraulic pump for use with a hydraulic tool. The hydraulic pump can include a variable speed motor that is controlled via an open-loop mechanism, wherein percentage motor power is controlled, or a closed-loop mechanism, where actual pump speed is controlled through a PID control mechanism. Furthermore, the hydraulic pump can include a manifold with primary and secondary overpressure protections, which can relieve overpressures in the hydraulic pump due to pump overpressures or external overpressures.

The description of the different advantageous embodiments has been presented for purposes of illustration and description and is not intended to be exhaustive or limited to the embodiments in the form disclosed. Many modifications and variations will be apparent to those of ordinary skill in the art. Further, different advantageous embodiments may provide different advantages as compared to other advantageous embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A hydraulic pump comprising:
a housing including a work port;
a bladder that stores hydraulic fluid;
a pump assembly that pumps hydraulic fluid from the bladder to the work port; and
a bladder relief assembly coupled to the bladder, the bladder relief assembly including a control element that is movable between a first position that seals the bladder to the atmosphere and a second position that opens the bladder to the atmosphere to relieve a pressure within the bladder, the control element moving from the first position to the second position when the pressure in the bladder reaches a set pressure.

2. The hydraulic pump of claim 1, further comprising a release valve positioned between the work port and the bladder to control fluid flow between the work port and the bladder.

3. The hydraulic pump of claim 2, wherein the release valve includes a knob extending outside the housing to allow a user to manipulate the release valve.

4. The hydraulic pump of claim 1, wherein the set pressure of the bladder relief assembly is adjustable.

5. The hydraulic pump of claim 1, wherein the bladder further comprises a removeable fill cap.

6. The hydraulic pump of claim 5, wherein the bladder relief assembly is coupled to the fill cap.

7. The hydraulic pump of claim 6, wherein the fill cap extends outside of the housing.

8. The hydraulic pump of claim 6, wherein the fill cap includes a head and a stem that couples to the bladder, the control element being moveably disposed in a passage extending between the head and the stem.

9. The hydraulic pump of claim 8, wherein the head includes a first passage and the stem includes a second passage that is selectively fluidly coupled by the control element.

10. The hydraulic pump of claim 9, wherein the first passage extends toward the stem and radially outward from the head.

11. The hydraulic pump of claim 10, wherein the head defines a flange and a distal end of the first passage is positioned along a side of the flange that faces the bladder.

12. The hydraulic pump of claim 1, wherein the housing includes a battery receptacle that is configured to couple to a battery to provide electrical power to the hydraulic pump.

13. The hydraulic pump of claim 1 further comprising a work port coupled to a manifold that is disposed inside the housing to allow fluid flow between the bladder and the work port, the work port configured to couple to an end effector that performs a work operation.

14. A bladder assembly for a hydraulic tool, the bladder assembly comprising:
a reservoir defining an internal cavity configured to receive hydraulic fluid; and
a fill cap removably coupled to the reservoir, the fill cap defining a passageway and including control element moveably disposed along the passageway, the control element movable between a first position that seals the internal cavity to the atmosphere and a second position that vents the internal cavity to the atmosphere to relieve a pressure within the bladder, the control element moving from the first position to the second position when the pressure in the bladder reaches a set pressure.

15. The bladder assembly of claim 14, wherein the set pressure is an adjustable set pressure.

16. The bladder assembly of claim 14, wherein the fill cap includes a stem that couples to the reservoir and a head that extends from the stem to be manipulable by a user, the head including a first segment of the passageway that extends toward an outer perimeter of the head and toward the reservoir.

17. A power tool comprising:
a housing including a battery receptacle;
a drive unit disposed within the housing;
a pump operatively coupled to the drive unit to provide a pressurized fluid;
a trigger that allows a user to control the drive unit to operate the power tool; and
a bladder assembly disposed in the housing, the bladder assembly including:
a reservoir defining an internal cavity configured to receive hydraulic fluid; and
a fill cap removably coupled to the reservoir, the fill cap defining a passageway and including a control element moveably disposed along the passageway, the control element movable between a first position that seals the internal cavity to the atmosphere and a second position that vents the internal cavity to the atmosphere to relieve a pressure within the bladder when the pressure in the bladder reaches a set pressure.

18. The power tool of claim 17, wherein the fill cap extends outside the housing to allow a user to vary the set pressure.

19. The power tool of claim 17, wherein the power tool includes a manifold having a work port that couples to an end effector that performs a work operation.

20. The power tool of claim 17, wherein the bladder includes a mounting bracket coupled between the reservoir and the fill cap, the mounting bracket couplable to the housing.
